(19) United States
(12) Patent Application Publication
(10) Pub. No.: US 2013/0289778 A1
(43) Pub. Date: Oct. 31, 2013

(54) CONTROL DEVICE, CONTROL METHOD, AND PROGRAM

(71) Applicant: Taichi Ishizaka, Tokyo (JP)

(72) Inventor: Taichi Ishizaka, Tokyo (JP)

(73) Assignee: MITSUBISHI ELECTRIC CORPORATION, Tokyo (JP)

(21) Appl. No.: 13/978,945

(22) PCT Filed: Jan. 25, 2011
(86) PCT No.: PCT/JP2011/051358

§ 371 Date: Jul. 10, 2013

(51) Int. Cl. G05D 23/19

(52) U.S. Cl. CPC G05D 23/193
USPC 700/276

(57) ABSTRACT

A sensor terminal location calculator calculates the location of a sensor terminal based on the distance to the sensor terminal obtained by each of a plurality of wireless adapters installed in a living space. Based on the calculated sensor terminal location and installation location information for each air-conditioning device (indoor device), a related air-conditioning device identifier identifies from among the plurality of air-conditioning devices (indoor devices), a related device that influences the environment in the vicinity of the sensor terminal. Based on the difference between the temperature detected by the identified related device and the temperature detected by the sensor, a corrected set temperature calculation unit corrects a target value for the temperature used by the related device for environmental control. A set temperature control executor controls the related device based on the corrected target value.

### TECHNICAL FIELD

The present invention relates to a control device, a control method and a program for controlling a plurality of air-conditioning devices that are installed at different locations in a living space in a home, a building or the like.

### BACKGROUND ART

With an air-conditioning device that is located in a building, the room temperature is typically controlled based on the temperature that is detected by a temperature sensor that is installed near an air intake, or a temperature sensor inside a remote control that is located on a wall and used for operating the air-conditioning device.

In this case, when the location where an occupant is actually located is distant from the installation location of the temperature sensor, the temperature of the location where the occupant is located sometimes does not obtain the set temperature. Particularly, when there are many heat-generating objects such as a personal computer and the like in the location where the occupant is located, it is believed that the temperature of the location where the occupant is located may not drop to the set temperature, resulting in a decrease in comfort.

Due to this kind of situation, air-conditioning systems have been disclosed in which temperature sensors are installed in a plurality of locations in a living space such as near a desk or a telephone to measure the temperature, and comfortable air-conditioning control is performed after accurately obtaining the temperature distribution in the a living space (for example, refer to Patent Literature 1).

### CITATION LIST

### Patent Literature

Patent Literature 1: Unexamined Japanese Patent Application Kokai Publication No. 2009-14219

### SUMMARY OF INVENTION

### Technical Problem

In the air-conditioning system disclosed in Patent Literature 1 above, when the layout of the living space changes, for example, when the location of a desk is changed, and the installation location of the attached temperature sensor changes, it is necessary to perform work to change the linkage between each temperature sensor and the air-conditioning device. This kind of work is very troublesome for a manager or occupants.

Moreover, in the air-conditioning system disclosed in Patent Literature 1 described above, it is necessary to install a plurality of temperature sensors. Temperature sensors are very expensive, with the cost per temperature sensor being in the tens of thousands of yen, so installing such an air-conditioning system requires an enormous cost.

The present invention is devised in consideration of the situation described above, and an object thereof is to provide a control device, a control method and a program that make it possible to reduce a workload, and increase comfort of the occupants at low cost.

### Solution to Problem

In order to accomplish the object above, the control device of the present invention is a control device that controls a plurality of air-conditioning devices that are installed at different locations in a specified living space. A plurality of wireless adapters are installed at different locations in the living space in order to acquire, through wireless communication with a portable terminal which is able to be carried including sensors for detecting environmental information related to air conditioning, a distance to the portable terminal and the environmental information that is detected by the sensors. A portable terminal location calculator calculates a location of the portable terminal inside the living space based on: distances to the portable terminal that are acquired by each of the wireless adapters and installation location information for each of the wireless adapters. A related device identifier, based on the location of the portable terminal that is calculated by the portable terminal location calculator and installation location information for each of the air-conditioning devices, identifies from among the plurality of air-conditioning devices, a related device that has an influence on an environment surrounding the portable terminal. A target value corrector, based on a difference between environmental information that is detected by the related device that is identified by the related device identifier and environment information that is detected by the sensor, corrects a target value for environmental information that is used in environment control of the related device. A control executor controls the related device based on the target value that is corrected by the target value corrector.

### Advantageous Effects of Invention

According to the present invention, based on the difference between environmental information for the location where the occupant is located that is detected by the sensor included in the portable terminal, and environmental information that is detected by a related device that influences the environment at that position, a target value for the environmental information that is used in environment control of the related device is corrected. As a result, it is possible for the environmental information for the location where the occupant is located to automatically approach a target value. According to the present invention, it is not necessary to perform adjustment of the location of sensors as the layout of living space changes, and it is not necessary to have a number of sensors, so it is possible to reduce the workload, and to improve comfort of the occupant at low cost.

### BRIEF DESCRIPTION OF DRAWINGS

FIG. 1 is a block diagram illustrating a configuration of an air-conditioning system according to Embodiment 1 of the present invention;

FIG. 2 is a block diagram illustrating a configuration of an air-conditioning control device in FIG. 1;

FIG. 3 is a flowchart of initial setting processing for various data in a data manager of a controller in FIG. 2;

FIG. 4 is a diagram illustrating an example (1) of a floor plan of a living space that is displayed on the display device in FIG. 2;

FIG. 5 is a diagram illustrating an example (2) of the floor plan of the living space that is displayed on the display device in FIG. 2;

FIG. 6 is a flowchart of sensor terminal location calculation processing that is executed by a sensor terminal location calculator in FIG. 2.

FIG. 7 is a diagram that schematically illustrates an example of calculation of a current location of a sensor terminal;

FIG. 8 is a diagram that schematically illustrates an example of processing that is executed by a related air-conditioning device identifier;

FIG. 9 is a flowchart of corrected set temperature calculation processing that is executed by a corrected set temperature calculator and a set temperature control executor;

FIG. 10 is a diagram comparing room temperature data that is measured by an air-conditioning device (indoor device) and a sensor terminal, respectively;

FIG. 11 is a diagram for explaining a state where the sensor terminal is carried around and a set temperature is automatically corrected;

FIG. 12 is a block diagram illustrating a configuration of an air-conditioning system according to Embodiment 2 of the present invention;

FIG. 13 is a block diagram illustrating a configuration of an air-conditioning control device in FIG. 12;

FIG. 14 is a block diagram illustrating a configuration of an air-conditioning system according to Embodiment 3 of the present invention; and

FIG. 15 is a block diagram illustrating a configuration of an air-conditioning control device in FIG. 14.

### DESCRIPTION OF EMBODIMENTS

Hereinafter, embodiments of the present invention will be explained in detail with reference to the drawings.

### Embodiment 1

First, Embodiment 1 of the present invention will be explained.

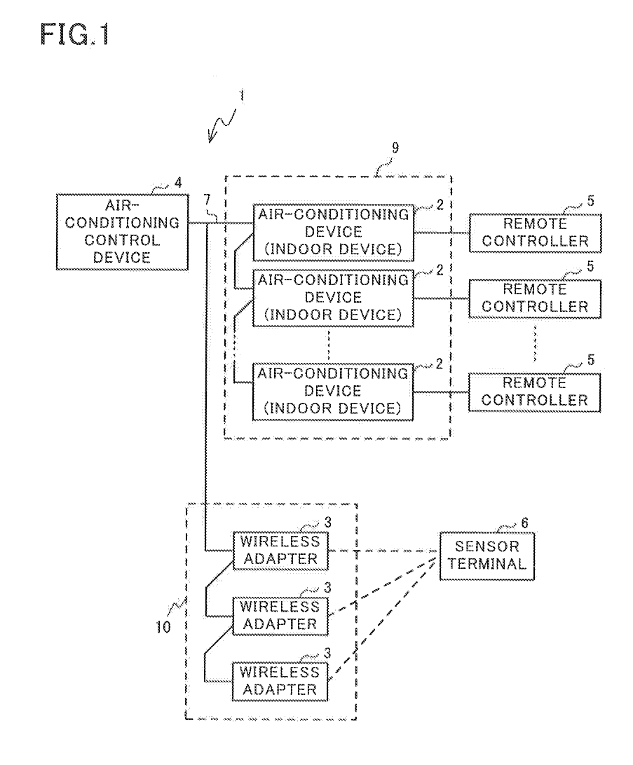

FIG. 1 illustrates a configuration of an air-conditioning system 1 of Embodiment 1 of the present invention. As illustrated in FIG. 1, the air-conditioning system 1 according to the present embodiment has a plurality of air-conditioning devices (indoor devices) 2, wireless adapters 3, an air-conditioning control device 4, remote controllers 5 and a sensor terminal 6.

The air-conditioning devices (indoor devices) 2, the wireless adapters 3 and the air-conditioning control device 4 are connected together by dedicated communication lines 7 such that communication is possible. The air-conditioning control device 4 which is not particularly illustrated in FIG. 1 is connected not only to the air-conditioning devices (indoor devices) 2, but is also connected to heat-source side devices (outdoor devices) having such as a compressor by way of the dedicated communication lines 7 such that communication is possible.

Furthermore, each of the remote controllers 5 that is capable of one operation of one of the air-conditioning devices (indoor devices) 2 is connected to the one of the air-conditioning devices (indoor devices) 2. The sensor terminal 6 is connected to the wireless adapters 3 by wireless communication. The sensor terminal 6 mainly reports the state of various sensors and sends replies to the wireless adapters 3.

Each of the plurality of air-conditioning devices (indoor devices) 2 is located at a different location in a specified living space. Each air-conditioning device (indoor device) 2 performs air conditioning of the living space under the control of the air-conditioning control device 4 so that the temperature of the living space approaches a set target temperature. The plurality of air-conditioning devices (indoor devices) 2 is also referred to as an air-conditioning device group 9.

Each of the plurality of wireless adapters 3 has a wireless communication function such as UWB (Ultra Wide Band), ZigBee or the like that is capable of measuring the distance between wireless terminals. Each wireless adapter 3 is capable of using this wireless communication function to measure the distance to the sensor terminal 6.

Moreover, each wireless adapter 3 relays data communication between the air-conditioning control device 4 and the sensor terminal 6. Each wireless adapter 3, during relay, converts data that is specified by a communication protocol of the dedicated communication lines 7 to data that is specified by a wireless communication protocol. As a result, the air-conditioning control device 4 and the sensor terminal 6 are able to communicate with each other by way of the wireless adapter 3. The plurality of wireless adapters 3 is also referred to as a wireless adapter group 10 below.

The remote controllers 5 are operation terminals for a user to operate the air-conditioning devices (indoor devices) 2. By operating the remote controller 5, it becomes possible, regarding a corresponding air-conditioning device (indoor device) 2, to run and stop, change an operating mode such as cooling and heating, change the target temperature, and change air direction and wind speed and the like.

In order to perform energy-saving control of the air-conditioning device (indoor device) 2, it is possible for the remote controller 5 to set a low-temperature limit for operation during cooling, and a high-temperature limit for operation during heating. For example, with this function, by the manager setting the low-temperature limit for cooling to 27° C., it becomes impossible for a user to set the indoor temperature of the remote controller 5 to less than 27° C.

The sensor terminal 6 is of a size that allows carrying as a portable terminal. The sensor terminal 6 includes various sensors for detecting temperature, humidity, CO₂ density and the like. The sensor terminal 6 periodically transmits temperature data, humidity data, CO₂ density data and the like that are detected by the various sensors to the air-conditioning control device 4 by way of the wireless adapter 3 using wireless communication.

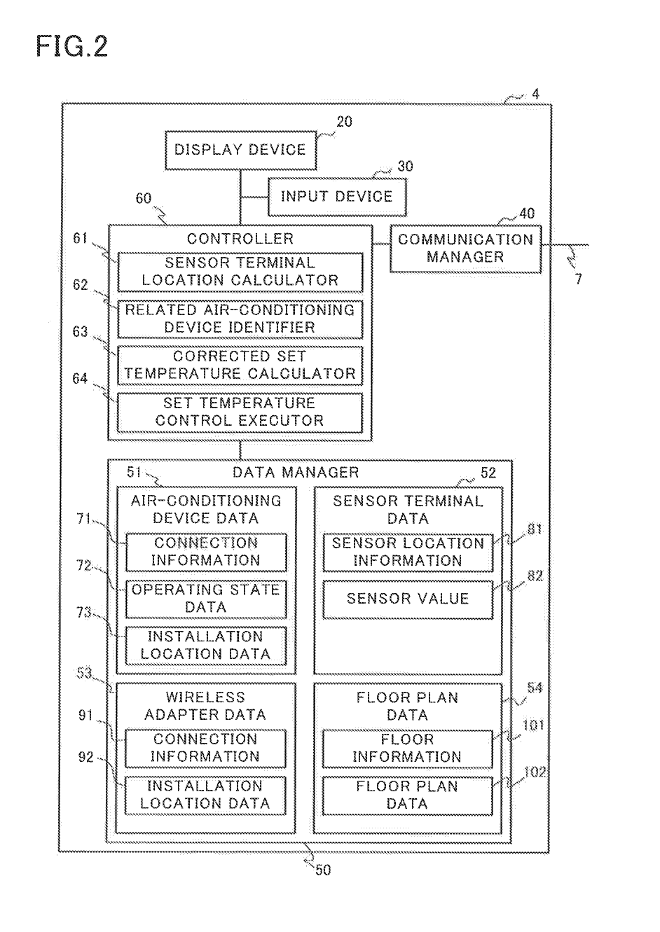

The air-conditioning control device 4 performs overall control and management of the air-conditioning device group 9 that includes the plurality of air-conditioning devices (indoor devices) 2. As illustrated in FIG. 2, the air-conditioning control device 4 has a display device 20, an input device 30, a communication manager 40, a data manager 50 and a controller 60.

The display device 20, under control of the controller 60, displays monitoring screens and operation screens of the operating state of the air-conditioning devices (indoor devices) 2, respectively. The display device 20 is also capable of displaying a floor plan of a living space and the like.

The input device 30 includes a touch panel, mouse, keyboard and the like. The touch panel is located on the display device 20. By the manager or the like operating the touch panel, mouse, keyboard or the like, signals are outputted to the controller 60 according to operation contents (for example, switching a monitoring screen, operating the air-conditioning device group 9, and giving instructions for various settings and the like).

The communication manager 40 is an interface with the dedicated communication lines 7. By way of this communication manager 40, data is transmitted to or received from the air-conditioning devices (indoor devices) 2.

The data manager 50 manages various data that is required by the controller 60 in order to perform control of the air-conditioning device group 9. The data managed by the data manager 50 is roughly classified as air-conditioning device data 51, sensor terminal data 52, wireless adapter data 53 and floor plan data 54.

The air-conditioning device data 51 includes connection information 71, operating state data 72 and installation location data 73 for each air-conditioning device (indoor device) 2.

The connection information 71 includes an address number, operation group number and model ID number for each air-conditioning device (indoor device) 2 that is managed by the air-conditioning control device 4. The connection information 71 is data that is required for controlling each air-conditioning device (indoor device) 2.

The operating state data 72 includes data that indicates a current operating state of the air-conditioning device (indoor device) 2, such as a running/stopped state of each air-conditioning device (indoor device) 2, an operating mode such as cooling or heating, a set temperature, and a room temperature. The operating state data 72 is constantly updated through exchanging data with the air-conditioning devices (indoor devices) 2.

The installation location data 73 includes data that indicates the installation location (floor number, location coordinates) of each air-conditioning device (indoor device) 2. That data expresses position coordinates (dot units) on a floor plan when the air-conditioning device is placed over an image of the floor plan of the living space, or expresses as a percentage the ratio of the location with respect to the overall vertical and horizontal size of the living space floor when a location on the floor plan (for example, the position in upper left corner) is taken to be a reference.

The sensor terminal data 52 includes sensor location information 81, which is location information for the sensor terminal 6, and sensor values 82.

The sensor location information 81 is data that indicates location information that is calculated by the air-conditioning control device 4 based on measurement results for the distance from the wireless adapter group 10. The sensor location information 81 is periodically updated according to the measurement results for the distance from the wireless adapter group 10.

The sensor values 82 are measurement values of various kinds of sensors built in to the sensor terminal 6 such as a temperature sensor, humidity sensor, CO₂ (carbon dioxide) density sensor and the like. The sensor values 82 are constantly updated to the various measurement values that are outputted from the sensor terminal 6 according to a monitor request that is transmitted to the sensor terminal 6 from the air-conditioning control device 4 at the timing of calculation of the sensor location information 81.

The wireless adapter data 53 includes connection information 91 and installation location data 92 for each wireless adapter 3.

The connection information 91 is data that is required for performing communication with each wireless adapter 3, such as an address number of each wireless adapter 3 that is managed by the air-conditioning control device 4.

The installation location data 92 is data that indicates an installation location (floor number, location coordinates) of each wireless adapter 3 in the living space. This data expresses position coordinates (dot units) on a floor plan when the air-conditioning device is placed over an image of the floor plan of the living space, or expresses as a percentage the ratio of the location with respect to the overall vertical and horizontal size of the living space floor when a location on the floor plan (for example, the position in upper left corner) is taken to be a reference.

The floor plan data 54 includes floor information 101, and floor plan data 102.

The floor information 101 is data that indicates the number of floors and size (image size) of the floors of the living space, and is set during the initial setting of the air-conditioning control device 4.

The floor plan data 102 is image data of the floor plan that is displayed on the display device 20 of the air-conditioning control device 4. This image data is created in a format such as a bitmap format, GIF (Graphics Interchange Format) or the like.

Data that is stored in the data manager 50 is constantly written and read by the controller 60.

The controller 60 has a CPU and memory (neither are illustrated in the figure). The CPU enables the function of the controller 60 by executing programs that are stored in the memory.

The controller 60 controls the air-conditioning device group 9 that includes the air-conditioning devices 2. The controller 60 includes a sensor terminal location calculator 61, a related air-conditioning device identifier 62, a corrected set temperature calculator 63 and a set temperature control executor 64.

The sensor terminal location calculator 61 calculates the location of the sensor terminal 6 based on the distances from the sensor terminal 6 that are obtained by each wireless adapter 3, and the preset installation location information (installation location data 92) of each wireless adapter 3. The calculated location data is stored in the data manager 50 as the sensor location information 81.

Based on the location of the sensor terminal 6 that is calculated by the sensor terminal location calculator 61 and the installation location information for each air-conditioning device (indoor device) 2, the related air-conditioning device identifier 62 identifies from among a plurality of air-conditioning devices (indoor devices) 2 a related air-conditioning device that influences the environment around the sensor terminal 6. More specifically, based on the sensor location information 81 for the sensor terminal 6 and the installation location data 73 for the air-conditioning device group 9, the related air-conditioning device identifier 62 identifies the air-conditioning device (indoor device) 2 that has the most influence on the location of the sensor terminal 6. In this embodiment, the air-conditioning device (indoor device) 2 that is closest in distance to the sensor terminal 6 is identified as the related air-conditioning device.

The corrected set temperature calculator 63, based on the difference between the temperature that is detected by the related air-conditioning device identified by the related air-conditioning device identifier 62, and the temperature that is detected by the sensor of the sensor terminal 6, corrects a target value for a room temperature that is used in environment control by the related air-conditioning device. More specifically, the corrected set temperature calculator 63 calculates the difference (temperature difference) between the temperature that is included in the sensor values 82, and included in the operating state data 72 of the related air-conditioning device identified by the related air-conditioning device identifier 62. Furthermore, in consideration of the calculated temperature difference, the corrected set temperature calculator 63 corrects the set temperature (target value) of the air-conditioning devices (indoor devices) 2 so that the measurement point obtains a proper room temperature, and calculates a corrected set temperature.

The set temperature control executor 64 controls the related air-conditioning device by transmitting a set temperature (target value) that is calculated by the corrected set temperature calculator 63 to the related air-conditioning device that is identified by the related air-conditioning device identifier 62.

Next, the operation of the air-conditioning control device 4 will be explained.

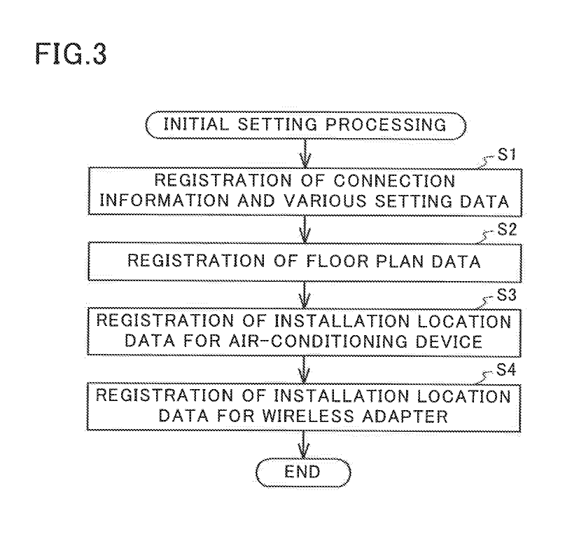

First, the initial setting processing for setting various data of the data manager 50 of the air-conditioning control device 4 will be explained. FIG. 3 illustrates a flowchart for the initial setting processing for setting various data of the data manager 50. This processing is executed after the air-conditioning system 1 has been started.

After the air-conditioning system 1 has been started, first, the controller 60, according to operation input to the input device 30, registers the connection information 71 of the air-conditioning device (indoor device) 2 that is to be the target of management, the connection information 91 for the wireless adapter 3 and various setting data in the data manager 50 (step S1).

Next, the controller 60, according to operation input to the input device 30, registers floor plan data for each floor of the living space as floor plan data 102 in the data manager 50 (step S2). The floor plan data 102 is allowed to be created using a personal computer or the like to be obtained from a removable medium such as a USB memory or the like. It is possible to create the floor plan data 102 by using a touch panel of the input device 30, and directly drawing a floor layout on the floor plan that is displayed on the display device 20, and selecting and arranging image parts such as walls, desks and the like.

Next, the controller 60, according to operation input to the input device 30, registers the installation location data 73 for each air-conditioning device (indoor device) 2 (step S3).

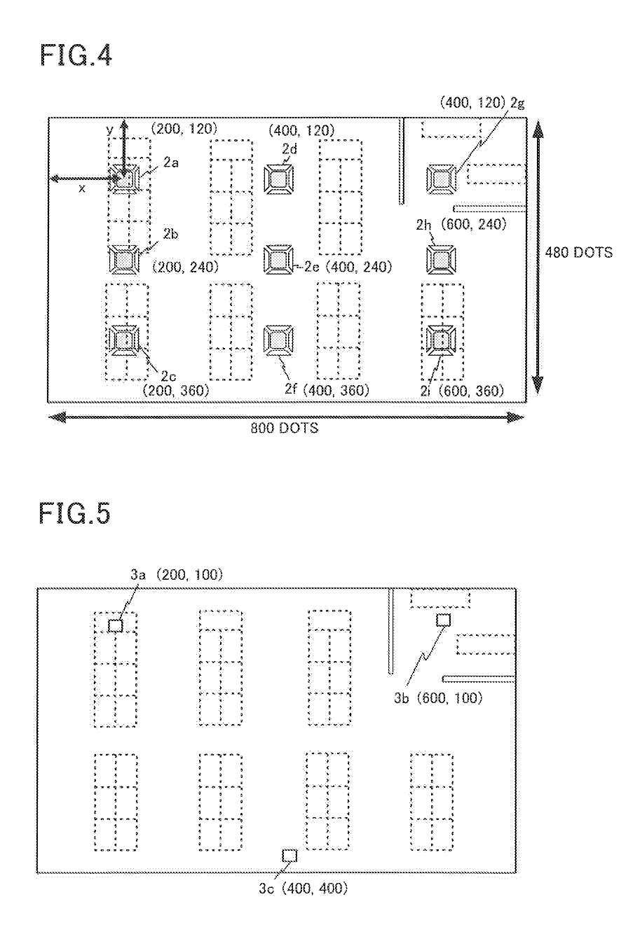

FIG. 4 illustrates an image that is displayed on the display device 20 based on a floor plan for a certain living space. In this image, a floor plan is displayed on the display device 20 of the air-conditioning control device 4 that is based on floor plan data that is registered in step S2, then in step S3, icons of the air-conditioning devices (indoor devices) 2 are arranged on that floor plan. The arrangement locations of the icons of the air-conditioning devices (indoor devices) 2 are set by dragging operation on the touch panel, or by inputting numerical values for a coordinate location, and then that data is registered in the data manager 50 as installation location data 73 for the air-conditioning devices (indoor devices) 2.

The floor plan illustrated in FIG. 4 has an image size of 800 dots in the horizontal direction and 480 dots in the vertical direction. On this floor plan, nine air-conditioning devices (indoor devices) 2a to 2i are arranged as air-conditioning devices (indoor devices) 2. For example, with an upper left corner as a reference (origin), the air-conditioning device (indoor device) 2a is arranged in the location (x coordinate, y coordinate)=(200, 120), the air-conditioning device (indoor device) 2b is arranged in the location (x coordinate, y coordinate)=(200, 240), and the air-conditioning device (indoor device) 2i is arranged in the location (x coordinate, y coordinate)=(600, 360).

Returning to FIG. 3, next, the controller 60, according to operation input to the input device 30, registers the installation location data 92 for each wireless adapter 3 (step S4).

In the example illustrated in FIG. 5, the floor plan that is registered in step S2 above is displayed on the display device 20. In FIG. 5, icons of wireless adapters 3a, 3b and 3c are arranged on that floor plan as the wireless adapters 3. For example, the wireless adapter 3a is arranged in the location (x coordinate, y coordinate)=(200, 100), the wireless adapter 3b is arranged in the location (x coordinate, y coordinate)=(600, 100) and the wireless adapter 3c is arranged in the location (x coordinate, y coordinate)=(400, 400).

The location of the icon of the wireless adapters 3 is set by dragging operation on the touch panel of the input device 30, or by inputting numerical values of coordinate locations, and arrangement location data thereof is registered in the data manager 50 as the installation location data 92.

At this point, the initial setting processing is finished.

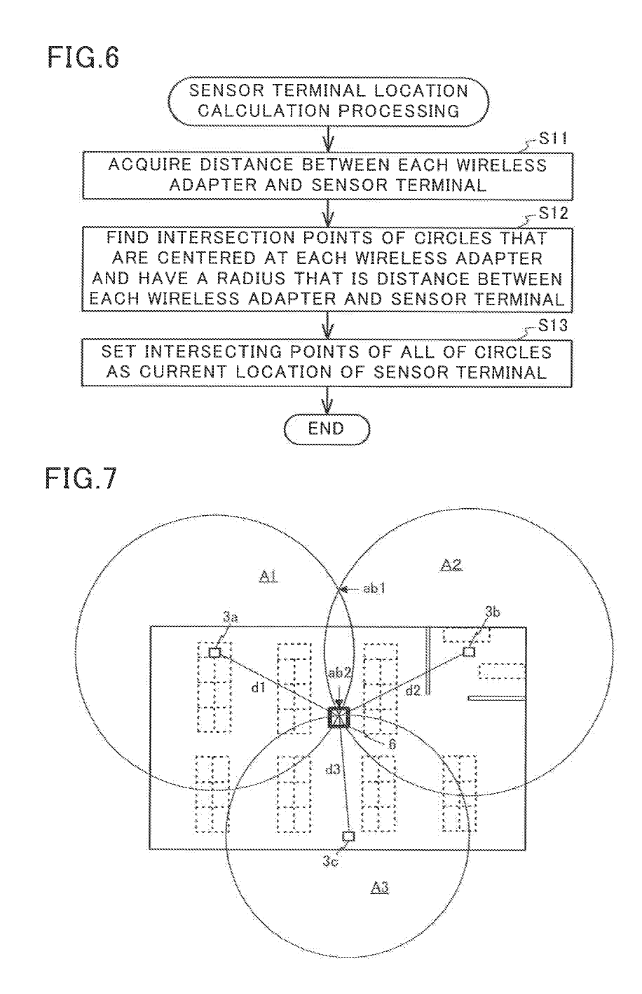

Next, the processing that is executed by the sensor terminal location calculator 61 is explained with reference to FIG. 6 and FIG. 7.

FIG. 6 illustrates a flowchart of sensor terminal location calculation processing. FIG. 7 schematically illustrates an example of calculating a current location of the sensor terminal 6.

In the example illustrated in FIG. 7, as with the example illustrated in FIG. 5, there are three wireless adapters 3 that measure the distance from the sensor terminal 6 (these are taken to be wireless adapters 3a, 3b and 3c, respectively), and the distances measured by each wireless adapter are taken to be d1, d2 and d3.

The sensor terminal location calculator 61 first obtains the distance between each wireless adapter 3 and the sensor terminal 6 from each wireless adapter 3 (step S11). For example, in the example illustrated in FIG. 7, the distances d1, d2 and d3 between the respective wireless adapters 3a, 3b, 3c and the sensor terminal 6 are obtained.

Returning to FIG. 6, the sensor terminal location calculator 61 then, based on the installation location data 92 for each wireless adapter 3, finds intersecting points of circles that are centered at each wireless adapter 3 and that have a radius equal to the distance between each wireless adapter 3 and the sensor terminal 6 (step S12). More specifically, the sensor terminal location calculator 61 generates equations for circles that are centered at each wireless adapter 3 and that have a radius equal to the distance between each wireless adapter 3 and the sensor terminal 6, and of those generated circles, calculates the intersecting points between a pair of circles by solving the equations for two circles as simultaneous equations.

In the example illustrated in FIG. 7, the equations for circles A1, A2 and A3 that are centered at coordinates of the wireless adapters 3a, 3b and 3c and that have radii that are equal to distances d1, d2 and d3 from the sensor terminal 6 are generated. Then, for example, by solving the equations for circles A1 and A2, intersecting points ab1 and ab2 are calculated. Here, the intersecting points for the circles A1 and A2, and circles A2 and A3 are found in a similar way.

Returning to FIG. 6, next, the sensor terminal location calculator 61 calculates intersecting points of all of the circles as the current location of the sensor terminal 6 (step S13). In the example illustrated in FIG. 7, the intersecting point ab2 is calculated as the current location of the sensor terminal 6.

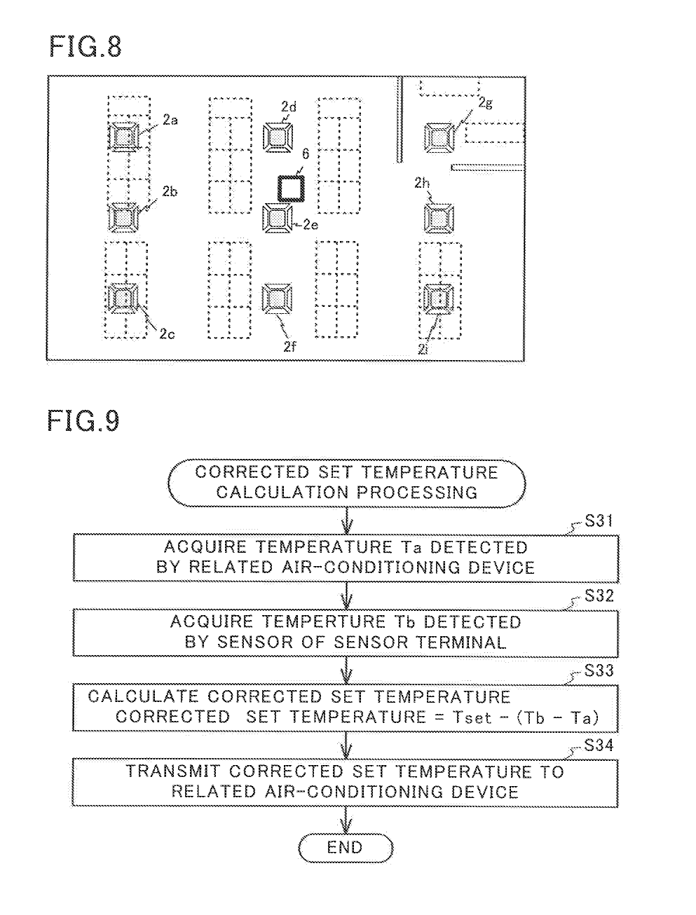

Next, the processing that is executed by the related air-conditioning device identifier 62 will be explained with reference to FIG. 8.

FIG. 8 illustrates an example of an image in which the installation locations of each of the air-conditioning devices 2a to 2i according to the installation location data 73 and the location of the sensor terminal 6 that is calculated by the sensor terminal location calculator 61 are superposed on the floor plan.

The related air-conditioning device identifier 62 calculates the air-conditioning device (indoor device) 2 that has the most influence on the air conditioning environment at the location of the sensor terminal 6 as the air-conditioning device that is closest in distance to the sensor terminal 6. In the example illustrated in FIG. 8, the air-conditioning device (indoor device) 2e is the closest air-conditioning device (indoor device) 2, so that the related air-conditioning device identifier 62 identifies this air-conditioning device (indoor device) 2e as the related air-conditioning device.

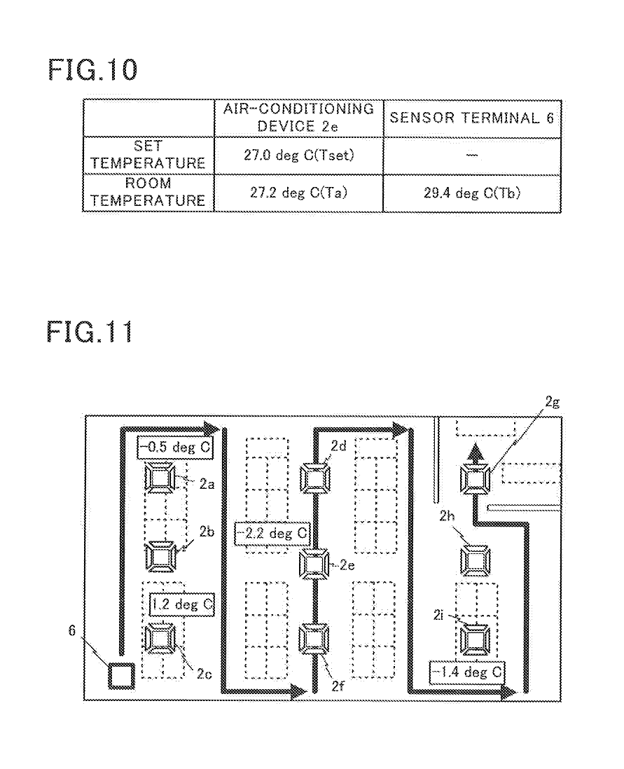

Next, the processing that is executed by the corrected set temperature calculator 63 and set temperature control executor 64 will be explained with reference to FIG. 9 and FIG. 10.

FIG. 9 illustrates a flowchart of the set temperature calculation processing that is executed by the corrected set temperature calculator 63. FIG. 10 illustrates a table that compares room temperature data measured by both the air-conditioning device (indoor device) 2e and the sensor terminal 6.

First, the corrected set temperature calculator 63 obtains temperature Ta detected by the related air-conditioning device (for example, air-conditioning device 2e) that is calculated by the related air-conditioning device identifier 62 (step S31). Next, the corrected set temperature calculator 63 obtains temperature Tb (sensor value 82) detected by the sensor of the sensor terminal 6 (step S32).

In the example illustrated in FIG. 10, the temperature detected by the air-conditioning device 2e is Ta=27.2° C., and the temperature detected by the sensor terminal 6 is Tb=29.4° C. In this example, at the location (height) where an occupant is actually located, the temperature does not obtain the set temperature Tset=27.0° C. that is set in the air-conditioning device (indoor device) 2e.

Returning to FIG. 9, the corrected set temperature calculator 63 uses the equation below to correct the set temperature (target value) (step S33).

Corrected set temperature=Set temperature (Tset)−(Room temperature at the sensor terminal 6 (Tb)−Room temperature at air-conditioning device (indoor device) 2 (Ta)) (1)

In the example illustrated in FIG. 10, the corrected set temperature obtains 27.0+(29.4−27.2)=24.8° C.

Returning to FIG. 9, next, the set temperature control executor 64 transmits the corrected set temperature that is calculated by the corrected set temperature calculator 63 to the related air-conditioning device (step S34). As a result, the air-conditioning environment is controlled so that the room temperature at the location where an occupant is located approaches the originally designated set temperature (27.0° C. in the example above).

In this embodiment, the air-conditioning device (indoor device) 2 that is closest to the sensor terminal 6 is selected as the related air-conditioning device for which the set temperature is corrected, however, the present invention is not limited thereto. For example, the related air-conditioning device identifier 62 is allowed to identify a certain air-conditioning device (indoor device) 2 within a specified range from the sensor terminal 6 as the related air-conditioning device, and the corrected set temperature calculator 63 is allowed to reduce the corrected value of the set temperature (target value) at the related air-conditioning device as the distance between the sensor terminal 6 and the related air-conditioning device becomes longer.

In this case, for example, the set temperature of a related air-conditioning device that influences the air conditioning is allowed to be corrected so that the distance or square of the distance is used as a weighting. For example, (Tb−Ta) in the equation (1) above is allowed to be divided by the distance or square of the distance and added to Tset to calculate the corrected set temperature.

Moreover, in the case where a wall or the like is entered on the floor plan, correction is allowed to be performed in consideration of the effect of the wall. For example, the closest air-conditioning device (indoor device) 2 or the air-conditioning device (indoor device) 2 that is within a certain range without a wall being located in between is allowed to be identified as the related air-conditioning device. In this case, location information of walls that divide up the living space is included in the floor information 101 for each living space, and the related air-conditioning device identifier 62 is allowed to identify the related air-conditioning device from among the air-conditioning devices (indoor devices) 2 that are not separated from the sensor terminal 6 by a wall.

Moreover, in this embodiment, the setting unit for the corrected set temperature is taken to be 0.1° C., however, by rounding off the value or using a conversion table, it is also possible to use 1° C. as the correctable set temperature unit. It is also possible not to correct the set temperature when the amount of correction is less than 1° C.

Moreover, in this embodiment, the air-conditioning control device 4 periodically monitors and obtains the location of the sensor terminal 6 and a temperature difference that is detected by the air-conditioning devices 2 and sensor terminal 6, however, this is not absolutely necessary. For example, it is also possible for the sensor terminal 6 or wireless adapters 3 to periodically notify the air-conditioning control device 4 of various data, and for the air-conditioning control device 4 to start the set temperature correction processing when the temperature difference is greater than a specified range.

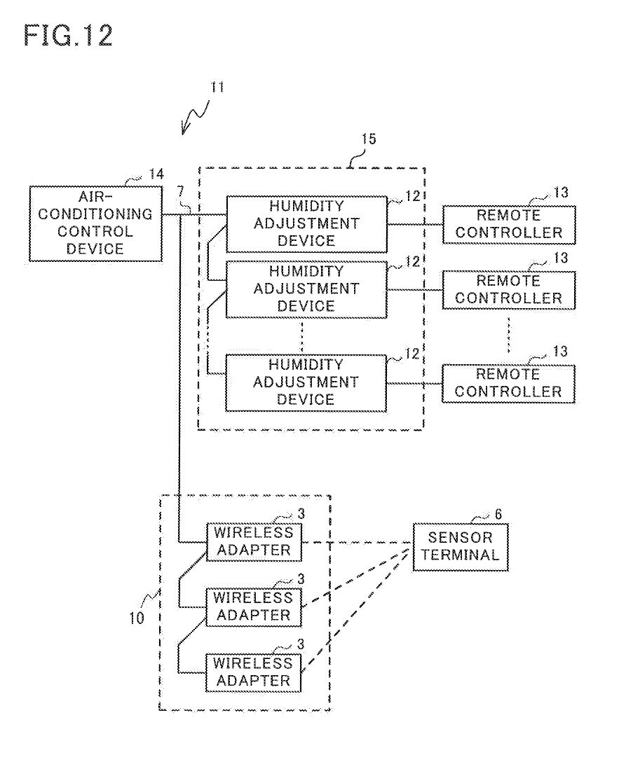

Moreover, it is also possible to start the correction processing when the sensor terminal 6 stops at the same position during a fixed amount of time. In this case, an occupant carries the sensor terminal 6, and for example, moves around the room along a path such as illustrated in FIG. 11, and while holding the sensor terminal 6, stops at the location where the set temperature is to be corrected, and corrects only the air-conditioning device (indoor device) 2 that is closest to where the occupant is located.

It is also possible to press a button on the sensor terminal 6 in order to transmit to the air-conditioning control device 4 an instruction to start correction for automatically performing correction of the set temperature.

Furthermore, in this embodiment, the case of using three wireless adapters 3 has been explained, however, it is also possible to improve the precision for measuring the location of the sensor terminal 6 by increasing the number of wireless adapters 3. It is also possible to measure the location of the sensor terminal 6 using a device other than the air-conditioning control device 4, and for the air-conditioning control device 4 to monitor measurement results for the location of the sensor terminal 6.

Moreover, in this embodiment, the corrected set temperature is always calculated using the same calculation equation, however, it is possible to change the calculation equation according to a season, outside temperature or time of day, and to change the set temperature correction width, and it is possible to perform learning control and store the correlation between a season, outside temperature, time of day and set temperature correction width in a table, and to use that correlation when correcting the set temperature next time.

Moreover, in this embodiment, the case of operation during cooling is explained, however, during heating, the correction direction is opposite to that during cooling and correction is performed in a direction to raise the temperature. In other words, during heating, instead of the equation (1), an equation (2) below is used.

Corrected set temperature=Set temperature (Tset)+(Room temperature at the air-conditioning device (indoor device) 2 (Ta)−Room temperature at the sensor terminal 6 (Tb)) (2)

In this embodiment, the case of changing the set temperature presuming that the air-conditioning devices (indoor devices) 2 are operating is explained, however, when the air-conditioning devices (indoor devices) 2 are stopped, it is also possible to automatically start operation of the air-conditioning devices (indoor devices) 2 by sending an operation command in addition to the set temperature.

Furthermore, the air-conditioning control device 4 (controller 60) is allowed to reference a temperature-color correlation table, which is stored by correlating temperatures with display colors, and read the color that corresponds to the temperature that is detected by the sensor terminal 6, then cause that color to be overlaid at the location of the sensor terminal 6 in an image of the floor plan that is displayed on the display device 20. By performing that operation at a plurality of locations, temperature distribution in the living space is displayed on the screen of the display device 20.

Moreover, in this embodiment, the sensor terminal 6 is such that various sensors and wireless functions are installed, however, the sensor terminal 6 is also allowed to have a display device and input device. In that case, the display device is allowed to have the floor plan as the background thereof to display the current location, temperature, movement path, temperature distribution and the like.

As explained above, with the air-conditioning control device 4 according to Embodiment 1, the target value for the room temperature that is used for environment control of the related air-conditioning device is corrected based on a difference between temperature at the location where an occupant is located, which is detected by a sensor included in the sensor terminal 6, and the temperature that is detected by the related air-conditioning device that has an influence on an environment at that position. Thereby, it is possible to bring the temperature at the location where the occupant is located closer to the target value. As a result it is possible to improve comfort of the occupant.

Further, with this embodiment, by simply walking around a living space while carrying the sensor terminal 6, the location where an occupant is located is automatically corrected to a specified room temperature, so the work of setting the temperature is simple and it is not necessary for a manager to correct the set temperature of the air-condition device group 9, and thus it is possible to reduce the work load.

Moreover, with this embodiment, the temperature is adjusted based on the location and detected temperature of the sensor terminal 6 that moves together with an occupant. Therefore, even in the case that a floor layout is changed, there is no need to perform work to change setting of the sensor location in the air-conditioning control device 4, so that system maintenance afterwards becomes simple.

Furthermore, with this embodiment, the installation location data 73 of air-conditioning devices (indoor devices) 2, and the installation location data 92 of wireless adapters 3 on a floor plan is converted to location coordinates on the floor plan and saved. As a result, a manager is able to operate the input device 30 while viewing the display device 20 of the air-conditioning control device 4 and easily set the location of the air-conditioning devices (indoor devices) 2 and wireless adapters 3.

With this embodiment, it is not necessary to install a lot of temperature sensors inside the living space, so that it is possible to reduce the cost of implementing a system.

Furthermore, with this embodiment, it is possible such as to boost the rate of air conditioning by narrowing it down to the location where an occupant is located, so that it is possible to reduce power consumed.

### Embodiment 2

Next, Embodiment 2 of the present invention will be explained.

FIG. 12 illustrates a configuration of an air-conditioning system 11 according to Embodiment 2 of the present invention. As illustrated in FIG. 12, the air-conditioning system 11 according to this embodiment differs from that of Embodiment 1 in that there is a plurality of humidity adjustment devices 12 instead of the air-conditioning devices (indoor devices) 2, there is an air-conditioning control device 14 instead of the air-conditioning control device 4, and there is a remote controller 13 instead of the remote controller 5.

The humidity adjustment devices 12, wireless adapters 3 and air-conditioning control device 14 are connected by the dedicated communication lines 7 so as to be able to communicate with each other. A remote controller 13 that is capable of one operation of each of the humidity adjustment devices 12 is connected to the each of the humidity adjustment devices 12.

A plurality of the humidity adjustment devices 12 are installed at different locations inside a specified living space, respectively. Each humidity adjustment device 12, under control by the air-conditioning control device 14, performs adjustment of the humidity in the living space so that the humidity in the living space approaches a set target value. The plurality of humidity adjustment devices 12 is also hereafter referred to as a humidity adjustment device group 15.

The remote controller 13 is an operation terminal for a user to operate the humidity adjustment device 12. By operating the remote controller 13, it is possible to start or stop operation of the corresponding humidity adjustment device 12, as well as it is possible to change target humidity of the corresponding humidity adjustment device 12.

The wireless adapters 3 and sensor terminal 6 have the same functions as those of Embodiment 1 above. In other words, each wireless adapter 3 measures the distance to the sensor terminal 6, and relays data between the sensor terminal 6 and the air-conditioning control device 14.

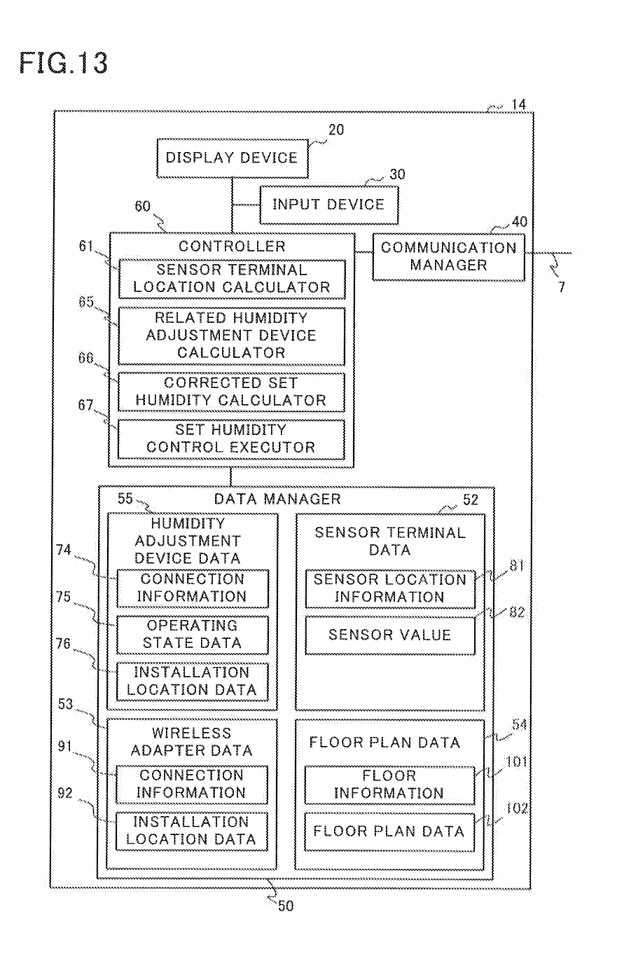

The air-conditioning control device 14 controls the humidity adjustment device group 15. FIG. 13 illustrates a construction of the air-conditioning control device 14. As illustrated in FIG. 13, the air-conditioning control device 14 is the same as the air-conditioning control device 4 in the embodiment described above in that the air-conditioning control device 14 has the display device 20, input device 30, communication manager 40, data manager 50 and controller 60.

The controller 60, in addition to the sensor terminal location calculator 61, has a related humidity adjustment device calculator 65, a corrected set humidity calculator 66 and a set humidity control executor 67. Moreover, humidity adjustment device data 55 is registered in the data manager 50.

The humidity adjustment device data 55 includes connection information 74, operating state data 75 and installation location data 76 for the humidity adjustment devices 12.

The connection information 74 includes data required for controlling each humidity adjustment device 12, such as the address number, operation group number, model ID information and the like for each humidity adjustment device 12 that is managed by the air-conditioning control device 14.

Operating state data 75 includes data that indicates a current operating state of the humidity adjustment devices 12 such as the running/stopped state of each humidity adjustment device 12, set humidity, room humidity and the like. The operating state data 75 is constantly updated through exchanging data with the humidity adjustment devices 12.

The installation location data 76 includes data that indicates an installation location (floor number, location coordinates) of each humidity adjustment device 12. That data is allowed to express position coordinates (dot units) on a floor plan when the air-conditioning devices are superposed on an image of the floor plan of the living space, or express as a percentage the ratio of the position with respect to the overall vertical and horizontal size of the living space floor when a position on the floor plan (for example, the position in upper left corner) is taken to be a reference.

The other configuration of the air-conditioning control device 14 is the same as that of the air-conditioning control device 4 according to Embodiment 1.

The initial setting processing, sensor terminal location calculation processing, related humidity adjustment device calculation processing, and corrected set humidity calculation processing by the air-conditioning control device 14 are the same as the initial setting processing, sensor terminal location calculation processing, related temperature adjustment device calculation processing, and corrected set temperature calculation processing that has been explained for Embodiment 1 except that the set temperature is replaced by humidity. Through the processing, the air-conditioning control device 14 controls air-conditioning environment by transmitting a corrected humidity to the humidity adjustment devices 12 so that the humidity where an occupant is located approaches the originally set humidity.

As explained in detail above, with the air-conditioning control device 14 according to Embodiment 2, a target value for the humidity that is used in humidity control of a related device is corrected based on a difference between the humidity of the location where an occupant is located that is detected by a sensor included in the sensor terminal 6 and the humidity that is detected by a related device that influences an environment at that location. Thereby, it is possible to make the humidity at the location where an occupant is located approach the target value. As a result, it is possible to reduce a workload, and to inexpensively improve comfort of the occupant.

### Embodiment 3

Next, Embodiment 3 of the present invention will be explained.

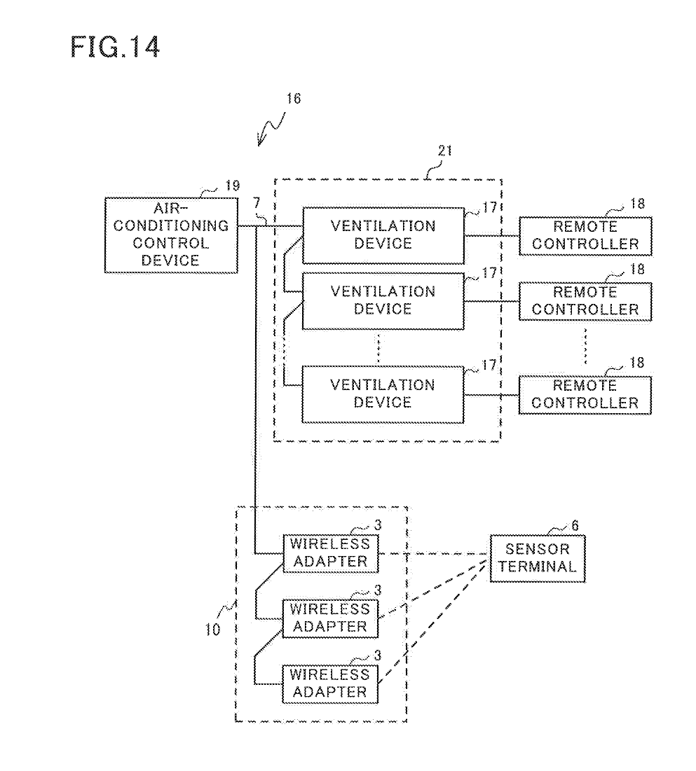

FIG. 14 illustrates a configuration of an air-conditioning system 16 according to Embodiment 3 of the present invention. As illustrated in FIG. 14, the air-conditioning system 16 according to this embodiment differs from that of Embodiment 1 in that provided are a plurality of ventilation devices 17 instead of a plurality of the air-conditioning devices (indoor devices) 2, an air-conditioning control device 19 instead of the air-conditioning control device 4, and remote controllers 18 instead of the remote controllers 5.

The ventilation devices 17, wireless adapters 3 and air-conditioning control device 19 are connected using the dedicated communication lines 7 so that communication with each other is possible. A remote controller 18 that is capable of one operation of each of the ventilation devices 17 is connected to the each of the ventilation devices 17.

The ventilation devices 17 are each located at different locations in a specified living space. Under the control of the air-conditioning control device 19, each ventilation device 17 performs ventilation of the living space so that the CO₂ (carbon dioxide) density in the living space reaches a target density or less. The plurality of ventilation devices 17 hereafter will also be referred to as a ventilation device group 21.

The remote controllers 18 are operation terminals for a user to operate the ventilation devices 17. By operating the remote controller 18, in addition to running or stopping the corresponding ventilation device 17, it is possible to change an air flow of the corresponding ventilation device 17.

The wireless adapters 3 and sensor terminal 6 have the same functions as those in Embodiment 1 described above. In other words, each wireless adapter 3 measures the distance to the sensor terminal 6, and relays data communicated between the sensor terminal 6 and the air-conditioning control device 19.

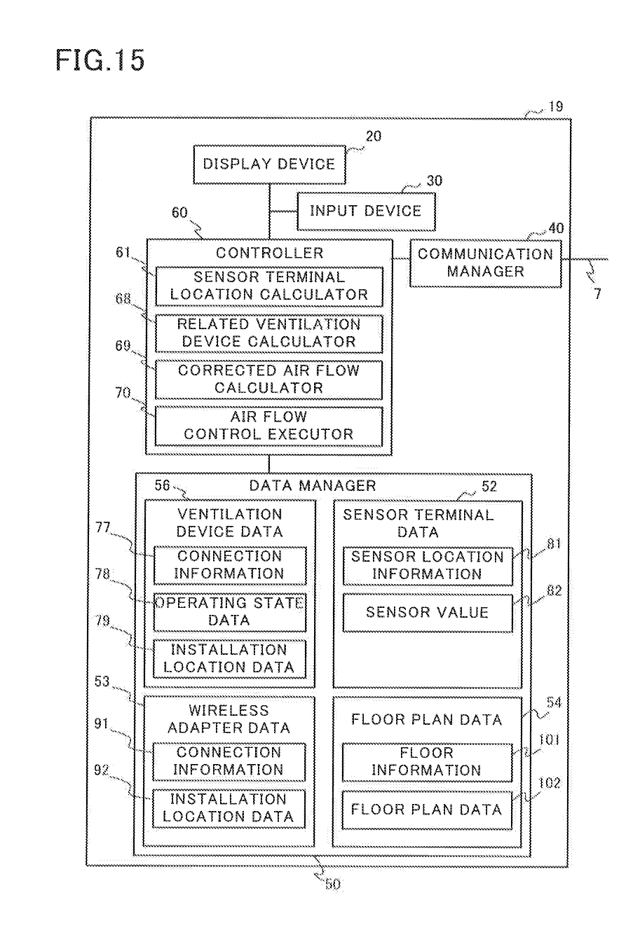

The air-conditioning control device 19 controls the ventilation device group 21. FIG. 15 illustrates a configuration of the air-conditioning control device 19. As illustrated in FIG. 15, the air-conditioning control device 19 is the same as the air-conditioning control device 14 according to the embodiment described above in that the air-conditioning control device 19 has the display device 20, the input device 30, the communication manager 40, the data manager 50 and the controller 60.

The controller 60, in addition to the sensor terminal location calculator 61, has a related ventilation device calculator 68, a corrected air flow calculator 69 and an air flow control executor 70. Moreover, ventilation device data 56 is registered in the data manager 50.

The ventilation device data 56 includes connection information 77, operating state data 78 and installation location data 79 for the ventilation devices 17.

The connection information 77 is data required for controlling each ventilation device 17, such as an address number, an operation group number, and model ID information for each ventilation device 17 that is managed by the air-conditioning control device 19.

The operating state data 78 includes data that indicates a current operating state of the ventilation devices 17, such as an running/stopped state, a ventilation mode, an air flow and the like of each ventilation device 17. The operating state data 78 is constantly updated through exchanging data with the ventilation devices 17.

The installation location data 79 includes data that indicates an installation location (floor number, location coordinates) of each ventilation device 17. That data is allowed to express position coordinates (dot units) on an indoor floor plan when the air-conditioning devices are superposed on an image of the floor plan of the living space, or express as a percentage a ratio of a position with respect to the overall vertical and horizontal size of the living space floor when a position on the floor plan (for example, the position in upper left corner) is taken to be a reference.

The other configuration of the ventilation control device 19 is the same as that of the air-conditioning control device 4 according to Embodiment 1 described above.

The initial setting processing, sensor terminal location calculation processing, related ventilation device calculation processing, and corrected air flow calculation processing by the air-conditioning control device 19 are the same as the sensor terminal location calculation processing, related air-conditioning device calculation processing, and corrected set temperature calculation processing that have been explained for Embodiment 1 except that the set temperature is replaced by air flow (including run and stop instructions). The air-conditioning control device 19 controls air-conditioning environment where an occupant is located by transmitting a corrected air flow (including run and stop instructions) to the ventilation devices 17 so that the CO₂ density where the occupant is located is decreased to a specified density or less.

In this embodiment, the air flow is adjusted according to the measured CO₂ density, however, in the case where the measured CO₂ density is less than a specified density, it is possible to stop the ventilation devices 17 and operate the ventilation devices only when it is necessary.

As explained in detail above, with the air-conditioning control device 19 according to Embodiment 3, a target value for the CO₂ density that is used in humidity control of a related device is corrected based on a difference between the CO₂ density of the location where an occupant is located that is detected by a sensor included in the sensor terminal 6 and the CO₂ density that is detected by a related device that influences the environment at that location. Thereby, it is possible to make the CO₂ density at the location where an occupant is located approach a target value. As a result, it is possible to reduce a workload, and to inexpensively improve comfort of the occupant.

In the embodiments above, a program that is executed is stored and distributed on a computer-readable recording medium such as a flexible disk, CD-ROM (Compact Disk Read-Only Memory), DVD (Digital Versatile Disk), MO (Magneto-Optical Disk) and the like, and the program is installed, so that a system that executes the processing described above is allowed to be configured.

Moreover, the program is allowed to be stored in a disk device or the like that is included in a specified server on a communications network such as the Internet so as to be superimposed on a carrier wave and downloaded, for example.

When the functions described above are achieved by being divided up in OS (Operating Systems) or achieved by the OS and applications working together, it is possible to only store a part other than that of the OS on a medium, and download the part.

Various embodiments and modifications are available to the present invention without departing from the broad sense of spirit and scope of the present invention. The above-described embodiments are given for explaining the present invention and do not confine the scope of the present invention. In other words, the scope of the present invention is set forth by the scope of claims, not by the embodiments. Various modifications made within the scope of claims and scope of significance of the invention equivalent thereto are considered to fall under the scope of the present invention.

### INDUSTRIAL APPLICABILITY

The present invention is suitable for environment control of a living space in which a plurality of environment control devices (air-conditioning devices (indoor devices), humidity control devices, ventilation devices and the like) are installed.

### REFERENCE SIGNS LIST

1 Air-conditioning system
2, 2a to 2i Air-conditioning device (indoor device)
3, 3a to 3c Wireless adapter
4 Air-conditioning control device
5 Remote controller
6 Sensor terminal
7 Dedicated communication line
9 Air-conditioning device group
10 Wireless adapter group
11 Air-conditioning system
12 Humidity adjustment device
13 Remote controller
14 Air-conditioning control device
15 Humidity adjustment device group
16 Air-conditioning system
17 Ventilation device
18 Remote controller
19 Air-conditioning control device
20 Display device
21 Ventilation device group
30 Input device
40 Communication manager
50 Data manager
51 Air-conditioning device data
52 Sensor terminal data
53 Wireless adapter data
54 Floor plan data
55 Humidity adjustment device data
56 Ventilation device data
60 Controller
61 Sensor terminal location calculator
62 Related air-conditioning device identifier
63 Corrected set temperature calculator
64 Set temperature control executor
65 Related humidity adjustment device calculator
66 Corrected set humidity calculator
67 Set humidity control executor
68 Related ventilation device calculator
69 Corrected air flow calculator
70 Air flow control executor
71 Connection information
72 Operating state data
73 Installation location data
74 Connection information
75 Operating state data
76 Installation location data
77 Connection information
78 Operating state data
79 Installation location data
81 Sensor location information
82 Sensor value
91 Connection information
92 Installation location data
101 Floor information
102 Floor plan data

1. A control device that controls a plurality of air-conditioning devices that are installed at different locations in a specified living space, comprising:
a portable terminal location calculator that calculates a location of a portable terminal inside the living space based on: distances to the portable terminal that are acquired through wireless communications with the portable terminal by each of a plurality of the wireless adapters installed at different locations in the living space; and installation location information for each of the wireless adapters, the portable terminal including sensors for detecting environmental information related to air conditioning;
a related device identifier that, based on the location of the portable terminal that is calculated by the portable terminal location calculator and installation location information for each of the air-conditioning devices, identifies from among the plurality of air-conditioning devices, a related device that has an influence on an environment surrounding the portable terminal;
a target value corrector that, based on a difference between environmental information that is detected by the related device that is identified by the related device identifier and environment information that is detected by the sensor, corrects a target value for environmental information that is used in environment control of the related device; and
a control executor that controls the related device based on the target value that is corrected by the target value corrector.

2. The control device according to claim 1, wherein
the related device identifier identifies a closest air-conditioning device to the portable terminal as the related device.

3. The control device according to claim 1, wherein
the related device identifier identifies the air-conditioning device in a specified range from the portable terminal as the related device; and
the target value corrector reduces a correction amount of the target value of the environmental information of the related device as a distance between the portable terminal and the related device becomes longer.

4. The control device according to claim 2, wherein
information related to a floor plan of the living space includes location information of walls that divide up the living space; and
the related device identifier, based on the location information of the walls, identifies the related device from among air-conditioning devices that are not separated from the portable terminal by the walls.

5. The control device according to claim 1, further comprising:
a memory that stores image data for a floor plan of the living space, installation location information for each of the air-conditioning devices in the image data, and installation location information for each of the wireless adapters in the image data;
a display device that displays an image of the floor plan based on the image data; and
an input device that inputs the installation location information for each of the air-conditioning devices and the installation location information for each of the wireless adapters based on operation input; wherein
the portable terminal location calculator converts the location of the portable terminal in the living space to a location in the image data; and
the related device identifier identifies the related device based on the location of the portable terminal that is converted to the location in the image data.

6. The control device according to claim 1, further comprising:
a memory that stores a correlation table that stores a correlation between the environmental information related to air conditioning and display colors, and image data of a floor plan of the living space;
a display device that displays an image of the floor plan based on the image data; and
a controller that refers to the correlation table to obtain a display color that corresponds to environmental information that is detected by the sensor and obtained from each of the wireless adapters, and overlays and displays the display color on the display device at the location of the portable terminal inside the image based on the image data that is calculated by the portable terminal location calculator.

7. The control device according to claim 1, wherein
the environmental information related to air conditioning includes at least one of an air temperature, a humidity and a carbon dioxide density.

8. A method of controlling a plurality of air-conditioning devices that are installed at different locations in a specified living space, the method comprising:
a portable terminal location calculation step of, by performing wireless communication with a portable terminal that is able to be carried including sensors that detect environmental information related to air conditioning, calculating the location of the portable terminal in the living space based on: distances to the portable terminal that are acquired by each of a plurality of wireless adapters that are installed at different locations in the living space; and installation location information for each of the wireless adapters;
a related device identification step of, based on the location of the portable terminal that is calculated in the portable terminal location calculation step and the installation location information of each of the air-conditioning devices, identifying from among a plurality of the air-conditioning devices a related device that influences environment around the portable terminal;
a target value correction step of, based on a difference between environmental information that is detected by the related device that is identified in the related device identification processing, and the environmental information that is detected by the sensors, correcting a target value of the environmental information that is used in environment control by the related device; and
a control execution step of, based on the target value that is corrected in the target value correction processing, controlling the related device.

9. A non-transitory computer-readable recording medium having stored thereof a program that causes a computer that controls a plurality of air-conditioning devices that are installed at different locations in a specified living space to function as:
portable terminal location calculation means that, by performing wireless communication with a portable terminal that can be carried including sensors that detect environmental information related to air conditioning, calculates the location of the portable terminal in the living space based on: distances to the portable terminal that are acquired by each of a plurality of wireless adapters that are installed at different locations in the living space; and installation location information for each of the wireless adapters;
related device identification means that, based on the location of the portable terminal that is calculated by the portable terminal location calculation means and installation location information of each of the air-conditioning devices, identifies from among a plurality of the air-conditioning devices a related device that influences an environment around the portable terminal;
target value correction means that, based on a difference between environmental information that is detected by the related device that is identified by the related device identification means and environmental information that is detected by the sensors, corrects a target value of environmental information that is used in environment control by the related device; and
control execution means that, based on the target value that is corrected by the target value correction means, controls the related device.

10. The control device according to claim 1, wherein when the sensors remain stationary for a given period, the target value corrector begins to correct the target value.

11. An air-conditioning system comprising:
the control device according to claim 1;
a portable terminal including sensors for detecting environmental information related to air conditioning; and
a plurality of wireless adapters installed at different locations in the living space so as to acquire a distance to the portable terminal and environmental information detected by the sensors through wireless communications with the portable terminal.
